(19) United States
(12) Patent Application Publication
(10) Pub. No.: US 2019/0040725 A1
(43) Pub. Date: Feb. 7, 2019

(54) METHOD FOR EXTRACTING HYDROCARBONS USING EXOTHERMIC GAS GENERATING CHEMICAL REACTIONS FRACTURING THE ROCK FORMATION

(71) Applicants: Dmitri Anatoljevich LEMENOVSKI, Moscow (RU); Zdenek KOLLER, Praha (CZ); Vladimira BENOVA, Praha (CZ)

(72) Inventors: Dmitri Anatoljevich LEMENOVSKI, Moscow (RU); Zdenek KOLLER, Praha (CZ); Vladimira BENOVA, Praha (CZ)

(21) Appl. No.: 15/758,764

(22) PCT Filed: Sep. 7, 2016
(86) PCT No.: PCT/CZ2016/000100

§ 371 Date: Mar. 9, 2018

(30) Foreign Application Priority Data
Sep. 10, 2015 (CZ) PV 2015-614

(51) Int. Cl. E21B 43/247; E21B 43/267

(52) U.S. Cl. CPC E21B 43/247; C09K 8/592; E21B 43/267

(57) ABSTRACT

Method for extracting hydrocarbons, including very heavy ones, using gas generating chemical reactions, wherein a compound for generating hot gases and initiators or, as the case may be, stabilizers for a chemical reaction are separately fed into the respective source bed in a controlled manner, where least four coplanar horizontal openings are created in each plane intersecting the location, where the compound and the initiators get together, and, simultaneously or after a specified delay, gas-forming substances are fed, said substances being contained in a mixture along with the compound or supplied separately, wherein the reaction takes place underneath a packer, whereby prerequisites for an artificial gas lift are created, whereupon the reaction is maintained by adding the compound, whereby such values of temperature and pressure are obtained which cause the solid rock to cleave.

### FIELD OF THE INVENTION

The present invention relates to a method for cleaving solid rocks as well as to a method for extracting hydrocarbons, including very heavy ones, using gas generating chemical reactions, without excluding soling rocks having a low degrees of porosity and permeability.

### BACKGROUND OF THE INVENTION

A generally known fact consists in that exploitation of crude oil having a higher viscosity or a low API gravity from rocks exhibiting low degrees of porosity and permeability encounters a number of difficulties. As far as gas extraction is concerned, the values of permeability and porosity may be significantly lower. For making crude oil exploitable, however, the relationship between permeability a viscosity of the fluid is important. The higher is the ratio representing the above relationship, the better is the exploitability of the respective fluid.

At the present, the exploitation of crude oil from the so called “tight formations” is primarily based on hydraulic methods for cleaving rocks. The latter methods are also suitable for the extraction of slate gas.

Another alternative consists in the utilization of diverse heat sources or other energy sources which have a capacity to decrease the viscosity of crude oil to an extent that the latter would be able to penetrate even through a relatively “tight” formation into the borehole. Recently, the global leading position has been held by steam-based and by the SAGD method, the latter being widely employed in Canada for exploiting crude oil from sandy and bituminous subsoils. Another method is based on decreasing the viscosity of crude oil by pumping CO₂ into the respective reservoir rock, which method is particularly widely employed in some regions where natural sources of CO₂ are available, mainly in the U.S.A., or where industrial facilities producing CO₂ exist in the vicinity of crude oil fields. Carbon dioxide is readily soluble in crude oil, thereby decreasing the viscosity thereof, while nitrogen, which is one of the products of chemical reactions, is poorly soluble in the same. Hence, the latter gas is not able to contribute to a pressure increase inside a borehole. The same applies to some other gases.

The above mentioned methods have numerous drawbacks. Hydraulic methods used for rock cleaving are strongly criticized by environmentalists and, moreover, are not suitable for regions where no adequate water sources are available. Moreover, the method is not considered to be suitable for very heavy, viscous types of crude oil. The consumption of water is always enormous. Usually, it is necessary to pump hundreds of tonnes water into a borehole in order to reach a pressure that is considered to be sufficient for causing rocks to cleave. This is due to the fact, that the required pressure levels are by tens of percent higher when compared to the geostatic pressure acting within the rock to be cleaved.

One of the known technical solutions is disclosed in the document WO2010/043239 A1, said technical solution being repeatedly applied in the Russian Federation and in the U.S.A. In this connection, it was demonstrated that an unlimited amount of chemical substances could be pumped into the respective rock, said chemical substances completely decomposing into gases (CO₂, N₂, H₂O in the form of steam), thereby releasing considerable amounts of energy.

The practical application of the technical solution disclosed in the above patent proved that the energy, which is obtained through chemical reactions, could be utilized for heating through a significant volume of the respective crude oil reservoir in a thorough manner and that, owing to the available high temperature, the so called “skin layer” could be efficiently eliminated within the distance of many meters or tens of meters from the borehole itself. The term “skin layer” may not be relevant when considerable distances from the borehole are concerned. Therefore, the above effect should be described in a simpler manner: when heated up, all the paraffins, asphaltenes, pitches and other “long-chained” hydrocarbons, which exist inside the collector within the distance of many meters from the borehole, are efficiently dissolved. Using the aforesaid method enables, unlike usual acid cleaning methods based on fierce chemical reaction inside a borehole body, the “skin layer” can be eliminated even within a distance of several tens of meters. In contrast to that, classic chemical cleaning methods do not provide a distance exceeding 0.3-1 m. This is clearly confirmed by the results achieved during the application of the present method in the boreholes located both in the Russian Federation and in the U.S.A. (Texas). Boreholes, which had not been yielding any crude for at least 15 years and which had not been revivable by means of any common method, began to yield tens of barrel of oil per day after having been treated by means of the present technology. The productivity of boreholes, which had yielded only small amounts of oil, has been increased by a multiple factor (4-6×). The above effect diminishes very slowly (an annual decrease not greater than 30% has been observed in many boreholes. The favourable effect of the above treatment is much more noticeable when crude oils having a higher paraffin contents are concerned.

So far, the above technology has been only applied in boreholes used for exploiting medium heavy oils. Nevertheless, this technology has a huge potential for being successfully used in boreholes intended for exploiting heavy and very heavy oils having very high viscosity levels (caused by paraffins, asphalts or pitches), as well. In combination with our newly introduced materials, the present technology may even replace the hydraulic cleaving method that is employed for formations having very low degrees of porosity and permeability.

The objective of the present invention is to provide a method for cleaving solid rocks and method for extracting hydrocarbons, including very heavy ones, using gas generating chemical reactions.

### SUMMARY OF THE INVENTION

The above drawbacks are eliminated by the method for cleaving solid rocks and extracting hydrocarbons, including very heavy ones, using gas generating chemical reactions according to the present inventions, wherein at least four coplanar horizontal openings are created in each plane intersecting the location, where a compound and initiators get together, and, simultaneously or after a specified delay, gas-forming substances are fed, either being contained in a mixture along with the compound or being supplied separately, said substances being selected from the group comprising
paraformaldehyde (C₃H₆O₃),
oxalic acid (C₂H₂O₄),
ethylene oxide (C₂H₄O),
formic acid (HCOOH),
hydroxylamine (NH₂OH),
nitromethane (CH₃NO₂),
ammonium carbonate ((NH₄)₂CO₃),
acetic acid (CH₃COOH),
amine based materials (NH₂), including waste ones,
ferric nitrate Fe(NO₃)₃,
   wherein the reaction always takes place underneath a packer, whereby prerequisites for an artificial gas lift are created, whereupon the reaction is maintained by adding a compound, whereby such values of temperature and pressure are obtained which cause the solid rock to cleave.

### PREFERRED EMBODIMENT OF THE INVENTION

The present technical solution extends the range of materials listed in the patent WO2010/043239 A1 and known as TGEC (Thermal Gas Emitting Composition) by adding a group of further materials which are capable of releasing gases in increased amounts (even though the respective reactions do not produce so much heat), said group also including several less expensive materials, such as those obtained from industrial waste. Thereby, the scope of possibilities of utilizing exothermic reactions for exploiting heavy crude oils or, as the case may, bitumens are considerably extended, especially when deep boreholes or those in poorly permeable rocks are concerned. Using gas for cleaving rocks poses a prospective method for reviving old, strongly flooded boreholes and for making the same exploitable. The process of releasing gases can be sufficiently rapid and capable of forming extensive arrays of new fissures even in the vicinity of flooded, virtually unproductive boreholes, said fissures providing access to crude oil that is “locked by water channels”. Needless to say, the origin of the crude oil plays a significant role. Experience shows that the treated boreholes are mostly less prone to flooding but several cases were observed when an increased production of crude oil was accompanied by an increased water-oil ratio. An extensive “purifying effect” (elimination of “long-chained hydrocarbons”) is usable in the most of the old boreholes containing light crude oil and an even more noticeable effect can be expected with crude oils having higher contents of paraffins and other similar substances. In such cases, the increase in production obtained may even reach several orders of magnitude.

The proposed method enables the heating-through process to take place in a targeted manner, i.e. in selected planes. Furthermore, a more efficient and precise rock cleavage can be achieved, this once, however, not through the action of water but through the action of gases developing during the chemical reaction. For the sake of protecting the structure of the borehole itself, using of other materials than those mentioned in the prior art documents is proposed. Some of the aforesaid materials do not generate required amounts of heat but they are still advantageous in that they decompose into a plurality of gases. Thus, such materials are possible sources of increased pressures. In general, the addition of various materials can enable a large volume of the oil reservoir concerned to be heated through, wherein the accompanying gases are capable of forming extensive fissures in the rock (this process is much more feasible in comparison with a cold rock). Another possibility consists in applying more readily reacting materials, whereby a large gas volume can be created during a very short period of time. Using an amount of reagents, which is sufficient for producing adequately pressurized gases, causes an abrupt pressure increase to occur enabling the respective rock to be cleaved more efficiently. The present method differs from that disclosed in the patent document WO2010/043239 A1 not only in that it provides an extended range of usable materials but also in that it enables a markedly better and precisely targeted preparation of the reaction zone to be carried out (e.g., by means of hydroperforation or by means of coiled tubing). Furthermore, it is possible to add a suitable amount of coarse sand or proppant to the chemical solutions used (mainly in deeper boreholes) in order to prevent the fissures obtained from being closed again under the influence of a high geostatic pressure. Compared to common hydraulic cleaving processes, one of the advantages of the present method consists in the possibility of utilizing higher temperatures making the method applicable to very heavy crude oils (the respective rock can be not only cleaved but also significantly warmed through. The present method can be repeatedly applied in the same borehole, the achievable results being always very effective. This is not possible when a standard hydraulic cleaving process is concerned. The technology is usable:
in horizontal boreholes where a remarkable increase of exploited quantities can be achieved
in a combination of boreholes wherein the central one is used for stimulation and the peripheral ones serve for production, thus utilizing the increased pressure (and heat) of gases for forcing oil towards the adjacent boreholes, i.e. for replacing water that is commonly used for this purpose. Thus, flooding of individual boreholes or of an entire oil field is not considered to be inevitable anymore and the present method can even be used for revitalizing such destroyed oil fields and for exploiting any remaining amounts of oil. The optimum geometrical layout of the boreholes should be determined by local geologists who are familiar with the properties of the respective oil field.
in common vertical boreholes with periodically repeated exploitation (where the period may be even longer than one year)
in common vertical boreholes with continuous stimulation and simultaneous exploitation

Compared to common hydraulic cleaving processes, the present method provides another significant advantage. As already mentioned above, all the reagents (except for a certain, but mostly marginal amount of the initiator) are converted into gases. When tens of tons of additional materials are pumped into a borehole, a similar amount of gases can be obtained inside the collector in the vicinity of the borehole during a short period of time. Consequently, a considerable pressure increase occurs both in the borehole and in the vicinity thereof. Under normal conditions (standard atmospheric pressure, temperature of about 25° C.), one tonne of such materials will generate a gas volume of about 1,000 m³. The above pressure may cause the rock to cleave but gases do not escape, at all (except for carbon dioxide that will dissolve in oil, thereby further decreasing the viscosity thereof). The increased pressure forcibly causes all the present fluids to flow into the locations where the lowest resistances are encountered, i.e. back into the borehole, through which the reagents have been pumped into the collector, or into the adjacent boreholes. During the activities carried out in Texas, it was possible to observe a pressure increase in the adjacent boreholes situated in a distance of about 100 m from the central borehole after having pumped a certain amount of reagents into the latter, the magnitude of the pressure change being up to several bar (more than 50 psi).

This may be considered to be a demonstrative example of hydropneumatic communication between boreholes owing to the development of an artificial gas list, though the latter in itself has not been achieved by pumping gases into the respective borehole. Moreover, a very noticeable spontaneous flow of crude oil was observed in many experimental boreholes in Russia as well as in some individual ones in Texas. When suitable material (reagents) are used, considerable amounts of carbon dioxide CO₂ and water H₂O in form of steam (the former causes the viscosity of crude oil to decrease and the latter either increases the pressure, when being present in gaseous state, or condenses, thus giving off additional heat) are released, accompanied by nitrogen N₂. Nitrogen neither dissolves nor condenses in oil and therefore it can significantly contribute to the formation of the above described artificial gas lift. Furthermore, it should be noted that many of the reagents listed below as well as those described in the patent documents WO2010/043239 A1 WO2012/025150 A1 release considerable amounts of oxygen or nitrogen dioxide NO₂ (or, as the case may be, nitrogen monoxide NO). Nitrogen oxides are strong radicals which, similarly to oxygen, cause crude oil to oxidize when a certain temperature is reached, thereby enabling other gases to form (CO₂+H₂O, and N₂ as an end product in case of nitrogen dioxide).

The Workflow can be Divided into Four Stages:

Hydroperforation.

Instead of a standard perforation method (based on the use of common perforators which fire simultaneous shots forming stacked openings or those arranged in a spiral pattern. If the velocity of such jet reaches about 150 m/sec, the same is able to perforate a steel pipe or a concrete wall. A water jet is able form multiple opening in a single plane which can be hardly accomplished by means of common perforators. An optimum number of openings corresponds 4-6 ones arranged in a single plane, but the actual number of openings will depend on the technical parameters of the respective borehole. This procedure is also applicable to old, previously perforated boreholes.

Such hydroperforation can be performed in multiple stacked levels, provided that the respective oil reservoir has an adequate thickness. Normally, 1 or 2 levels are occupied but, depending on the composition of the geological formation concerned and particularly on the thickness and structure of the oil reservoir, 5 or more levels may be reasonable.

A water jet or a jet of a fluid containing sand particles is normally capable of forming opening that are as long as 2 metres (depending on the nature of the rock concerned and on the available technical equipment). Using a so called “coiled tubing” enables long channels to be formed, even those having several hundreds of meters in length, which, however, does not pose any necessary precondition for the purpose of the present disclosure. Nevertheless, such long channel may be useful.

Long parallel channels are proposed, among others, in the patent document no. WO2012/025150 A1 (The Method and Apparatus for Thermally Treating an Oil Reservoir), wherein, however, the particular objective is to replace or modify the SAGD method in order to enable crude oil to be pumped through the same borehole, which is simultaneously being used for the thermal stimulation of the oil reservoir, without restricting the depth of the borehole in any way. With regard to the present disclosure, there is no need for stacked pairs of channels and the use of the aforesaid channels pursues another objective, namely making rock cleavage easier and more precise and enabling a subsequent utilisation of a gas lift (when “huff & puff” exploitation takes place, the gases developing during the final stage of the stimulation force a certain amount of oil towards the surface, thereby eliminating the need of immediate lowering pumps into the borehole). If the packer is placed in the centre of the perforation and one of the channels is used for feeding a suitable TGEC material into the borehole, then the other channel is used for expelling crude oil from the borehole due to the action of the gases being formed. Another exemplary objective consists in establishing hydropneumatic communication between multiple boreholes if one or more of them are continuously used for stimulation.

Hydraulic Cleaving

Let us suppose that a crude oil reservoir having low permeability is concerned. Afterwards, the openings, which have been prepared in accordance with the above procedure, are filled with a suitable material solution (TGEC) that will be capable of being decomposed into gases. Simultaneously, an initiator (RIS—Reaction Initiator and Stabilizer) is added through one of the other channels. Later, coarse sand will be gradually added to the TGEC solution. The grain size of such sand should range between 1 and 2 mm. After reaching a particular temperature, it will be possible to replace the above materials with other ones in order to enable large amounts of gases to be generated (thus making the exothermic nature of the reaction less distinctive). Thereby, it will be enable to considerably extend the structured fissures obtained. In the case of need, said fissures can be filled with sand or with another suitable material that will enable to keep them permanently open.

Another suitable material may be, in addition to sand, an artificial proppant. Nevertheless, it is necessary to verify that such proppant is sufficiently heat resistant and that it will not react with other chemicals used. After the temperature begins to decrease below a certain threshold, it is possible to re-proceed with pumping materials having a higher energetic performance, i.e. materials that are capable of being involved in reactions producing temperatures of up to several hundreds of ° C. It is a matter of course that suitable mixtures of such materials (reagents) can be used, as well. This would enable to maintain the temperature within acceptable limits and to simultaneously obtain a very high pressure, which may be important and desirable in a number of instances.

The obtained fissures will have a diameter of about 5 mm which means that it will be necessary to select a proppant or sand having an adequate grain size for penetrating into the fissures and for preventing undesirable lumps from forming inside the fissures. It is assumed that the fissures will become longer with decreasing thickness of the oil reservoir concerned. Rock cleavage will be take place more readily in zones exhibiting higher porosity degrees (in a collector) because the penetration of gas will be facilitated in such zones in comparison to those having low porosity, the latter containing negligible amounts of oil or gas.

Accordingly, tens to hundreds of cubic metres of chemicals containing sand distributed therein will be gradually pumped into the oil reservoir, the upper limit being defined merely by a related economic calculation. Advantageously, a continuous process can be carried out which means that only the spaces, which have been prepared in advance, are initially filled with the chemical (TGEC), subsequently a reaction is ignited and, afterwards, the reaction is maintained in order that the volume (and pressure) of the gases being developed and simultaneously the temperature of the same can be gradually increased (which will facilitate the rock cleavage).

Ignition of the Reaction

The reaction will always take place underneath a packer. Under certain circumstances, 2 packers will have to be used (the second one will be placed under the intended working zone). The aforesaid 2 packers should be used where the artificial gas lift is to be used permanently or where a certain delimited working layer is concerned. The same applies to thicker oil reservoirs, to a plurality of stacked reservoirs or to individual reservoirs selected for treatment among a plurality of reservoirs. Two packers will also be used in the case that individual portions of a long horizontal borehole will be gradually treated.

The Reaction can be Ignited in Several Different Ways
it is possible to use a fuse for igniting a primer that will subsequently initiate the reaction
alternatively, it is possible to lower some chemical products through the tubing assembly (riser) into the perforation zone, the properties of such products being similar to those of rocket fuels or torpedo propellants (preferably starting to react when being brought in contact with water).

Therefore, such products can be enclosed in capsules, the latter being capable of opening when arriving in the perforation zone. The heat development, which takes place after the ignition of the aforesaid products, will initiate the decomposition of ammonium nitrate, organic saltpetre or other chemical compounds. A reaction, which will cause the main chemical (TGEC) to decompose, can be initiated in a chemical manner (e.g. using sodium tertraborate, sodium nitrate or some other salts, provided that a correct pH value is observed). An electrically initiated reaction is also possible which, however, has specific drawbacks.

In general, it is advisable to use other chemicals for initiating a reaction, as described in the patent document WO2010/043239 A1. An undisputed advantage of the present method consist in the possibility of working in a continuous manner. Besides that, the method provides the capacity of controlling the respective reaction which means that an excessively rapid reaction can be impeded by adding a suitable inhibitor (or by decreasing the concentration of the TGEC solution used). In case that the reaction is running to slowly, it can be revived by adding a suitable initiator (RIS).

Maintaining the Reaction

After having reached an adequate temperature, the original chemicals can be replaced with other ones which can serve as a source of large amounts of oxygen (e.g., to metal nitrates or dichromates, permanganates and other compound, including air, provided that the latter is allowed to be pumped, into the borehole), thus enabling the hydrocarbons contained in the rock to be used as a source of energy. Again, suitable oxidizing agents and other materials can be added to the solution in order to increase the volume of the gases being developed, thus simultaneously increasing the pressure without causing any noticeable rise in temperature.

Materials, which release hydrogen when being subject to a reaction (such as a suspension of pulverized metals in an acid or base) can also be used. In this case, a certain amount of hydrogen can cause a small portion of the hydrocarbons to undergo hydrocracking, which makes it possible to partially permanently increase the API value and to decrease the viscosity. This would influence the transportation of very heavy crude oil by means of oil pipelines in regions with cold climates. It should be noted that hydrogen is multiple times lighter than nitrogen or carbon dioxide; therefore the same weight will provide much more molecules and thus also enables a correspondingly higher pressure level to be achieved.

For maintaining the reaction, it is important to provide for a reliable temperature and pressure measuring apparatuses which are installed in at least two locations. The provision of accurate information relating to the changes in pressure and temperature is an essential prerequisite for an enhanced control of the entire process.

Gaseous Thermal Rock Cleavage

Once ignited, the reaction can be controlled with regard to the progress thereof. Simultaneously, the temperature or pressure can be increased until a level is reached the will cause the respective solid rock to cleave. The progress of the reaction can be controlled by adjusting the flow rate of the reagents being pumped (possibly mixed with sand or with a suitable proppant) into the borehole or by pumping a suitable inhibitor enabling the temperature inside the borehole to be maintained within predetermined limits. Likewise, suitable reagents, which do not noticeably cause a rise in temperature (if any), can be admixed. When adequately selected, the sand or proppant carriers react slowly, thereby being capable of transporting sand into recently formed fissures and of widening such fissures accordingly. Just as during a usual cleaving process, the fissures will predominantly form in the horizontal direction or, to be more precise, where a lower porosity degree prevails, i.e. in the direction characterizing the situation of the respective crude oil reservoir from the structural and geological point of view (notwithstanding various geological defects, dislocations or distinct inhomogeneities). An undisputed advantage in comparison to hydraulic cleaving methods consists in the fact that it is not necessary to maintain any huge pressure in the zones having a gradually increasing distance from the source of such pressure (which eliminates the need of using powerful pumps) because the decomposition reaction of the liquid reagents takes place directly in the location, where the respective rock is being cleaved, or in the close vicinity of such location. Moreover, such decomposition reactions are strongly exothermic which means that those reactions cause the collector to be efficiently heated up, thereby decreasing the strength of the same. Thus, the cleavage can occur under a reduced pressure in comparison to that required for a hydraulic rock cleaving process.

1. A method for extracting hydrocarbons, including very heavy ones, using gas generating chemical reactions, wherein a compound for generating hot gases and initiators or, as the case may be, stabilizers for a chemical reaction are separately fed into the respective source bed in a controlled manner, wherein at least four coplanar horizontal openings are created in each plane intersecting the location, where the compound and the initiators get together, and, simultaneously or after a specified delay, gas-forming substances are fed, said substances being contained in a mixture along with the compound or supplied separately, wherein the reaction takes place underneath a packer, whereby prerequisites for an artificial gas lift are created, whereupon the reaction is maintained by adding the compound, whereby such values of temperature and pressure are obtained which cause the solid rock to cleave.

2. The method according to claim 1, wherein the gas forming substances are selected from the group containing
paraformaldehyde (C₃H₆O₃),
oxalic acid (C₂H₂O₄),
ethylene oxide (C₂H₄O),
formic acid (HCOOH),
hydroxylamine (NH₂OH),
nitromethane (CH₃NO₂),
ammonium carbonate ((NH₄)₂CO₃),
acetic acid (CH₃COOH),
amine based materials (NH₂), including waste ones, and
ferric nitrate Fe(NO₃)₃,
wherein the reaction will always take place underneath a packer, whereby prerequisites for an artificial gas lift are created, whereupon the reaction is maintained by adding a compound, whereby such values of temperature and pressure are obtained which cause the solid rock to cleave.

3. The method according to claim 1, wherein the ignition of the reaction is followed by feeding a mixture of the compound and sand and/or an artificial proppant in order that the obtained fissures can retain their dimensions.

4. The according to claim 1, wherein reagents, possibly contained in a mixture together with sand or with a proppant, are fed into one or more stimulation boreholes and the hydrocarbons are extracted from the adjacent boreholes, the accompanying formation of gases occurring, provided that an adequate geometrical arrangement exists, in an amount that is sufficient for causing a strong gas lift to occur, thus enabling the hydrocarbons to spontaneously flow from the adjacent boreholes, a possibility of using standard pumping methods for the exploitation from the adjacent boreholes being thereby not excluded.

5. The method according to claim 1, wherein one or more stimulation boreholes extending in parallel to the main bore hole are created, the main borehole being supplied with reagents, possibly contained in a mixture together with sand or with a proppant, and the hydrocarbons are extracted from the adjacent boreholes, the accompanying formation of gases occurring, provided that an adequate geometrical arrangement exists, in an amount that is sufficient for causing a strong gas lift to occur, thus enabling the hydrocarbons to spontaneously flow from the adjacent boreholes, a possibility of using standard pumping methods for the exploitation from the adjacent boreholes being thereby not excluded.
